(19) United States
(12) Patent Application Publication
(10) Pub. No.: US 2024/0123597 A1
(43) Pub. Date: Apr. 18, 2024

(54) POWER TRIGGER MECHANISM, METHOD OF OPERATING A POWER TRIGGER MECHANISM, AND POWER TOOL HAVING THE SAME

(71) Applicant: TECHTRONIC CORDLESS GP, Anderson, SC (US)

(72) Inventors: Po Sum LEE, Kwai Chung (CN); Le Dong CHEN, Kwai Chung (CN)

(21) Appl. No.: 18/481,649

(22) Filed: Oct. 5, 2023

(30) Foreign Application Priority Data
Oct. 14, 2022 (EP) 22201686.7

(51) Int. Cl. B25F 5/02

(52) U.S. Cl. CPC B25F 5/02

(57) ABSTRACT

Aspects of the present disclosure relate to a power trigger mechanism for a power tool, comprising a first locking device and a second locking device, wherein the first locking device and the second locking device can be actuated independently of each other. Further aspects of the present disclosure relate to a power tool comprising said power trigger, and a method of operating said power trigger. The present invention provides a power trigger with intuitive operation, improved safety and improved control and stability of the power tool.

### FIELD

The present disclosure relates to a power trigger mechanism, particularly a power trigger mechanism for a power tool. Particularly, the present disclosure relates to a power trigger mechanism having two locking devices. Further, the present disclosure relates to a method of operating said power trigger mechanism, and a power tool having said power trigger mechanism.

### BACKGROUND

In order to meet regulatory requirements, many types of power tools are required to have at least one locking device for locking the actuation of a power trigger. Typically, such a power tool would include a power trigger which, upon actuation by an operator, would activate the power tool. The at least one locking device is designed to prevent or inhibit actuation of the power trigger when in a locked state. Once the at least one locking device is actuated into an unlocked state, the power trigger is then free to be actuated by the operator. For some types of power tools, regulations require at least two locking devices. Such a mechanism requires the actuation of at least two locking devices into their respective unlocked states before the power trigger is allowed to be actuated.

Power trigger mechanisms common in the state of the art include a trigger lever which is actuated by one or more fingers of the operator, and a locking device arranged o be operated by the palm of the operator. The power tool is grasped with the hand and the locking device is actuated, allowing actuation of the unlocked trigger lever.

One example from the state of the art includes a power trigger mechanism which incorporates a thumb-actuated second locking device in the form of a button mounted on the side of the grip of the power tool. The button, when depressed by the thumb of the operator, is unlocked to allow actuation of the first palm-operated locking device. Similar to the first example, two distinct motions are required to be performed in the specified sequence to allow actuation of the trigger lever. Further, locking devices which are arranged on the side of the power tool can only be operated by one specific hand of the operator, and are not ambidextrous.

Another example of the state of the art, as described in United States patent application publication no. US 2019/358801 A1, includes a power trigger mechanism which incorporates a second locking device in the form of a lever mounted to the first locking device. Similar to the previous examples of the background art, the operator must first actuate the lever into an unlocked state, so as to allow the actuation of the first locking device by the palm of the operator.

In view of the above-mentioned examples in the current state of the art, improvements to power trigger mechanisms are sought. The present invention provides a power trigger mechanism having improved safety, is more intuitive and flexible to operate, is ambidextrous, and allows for improved control and stability in handling by the operator.

### SUMMARY

In light of the above, a method and apparatuses for a power trigger mechanism are provided according to the independent claims. Further aspects, advantages, and beneficial features are apparent from the dependent claims, the description, and the accompanying drawings.

According to a first aspect of the present disclosure, a power trigger mechanism is provided. The power trigger mechanism includes a trigger lever configured to be actuated by an operator, a first locking device and a second unlocking device. The first unlocking device is configured to be actuated by the operator into an unlocked state, and configured to return to a locked state in which an actuation of the trigger lever is inhibited. The second locking device configured to be actuated by the operator into an unlocked state, and configured to return to a locked state in which an actuation of the trigger lever is inhibited. The first locking device and the second locking device are configured to allow an actuation of the trigger lever only when both the first and second locking devices are in the respective unlocked states. The first locking device can be actuated independently of the state of the second locking device, and the second locking device can be actuated independently of the state of the first locking device.

According to a second aspect of the present invention, a power tool is provided. The power tool includes an energy source, a motor element, and the power trigger mechanism according to the first aspect.

According to a third aspect of the present invention, a method of operating a power trigger mechanism is provided. The power trigger mechanism includes a trigger lever, a first locking device configured to be actuated into an unlocked state, and configured to return to a locked state in which an actuation of the trigger lever is inhibited, and a second locking device configured to be actuated into an unlocked state, and configured to return to a locked state in which an actuation of the trigger lever is inhibited, wherein the first locking device and the second locking device are configured to allow an actuation of the trigger lever only when both the first locking device and second locking device are in the respective unlocked states, the method including actuating one of the first locking device and the second locking device from the locked state to the unlocked state, actuating the other one of the first locking device and the second locking device from the locked state to the unlocked state, and actuating the trigger lever.

Further aspects, details and embodiments become apparent from the following description together with the figures and the dependent claims.

Aspects and embodiments of the present disclosure allow for the independent operation of the two locking devices such that the operator does not require a specific sequence of unlocking each locking device, leading to more flexible and intuitive operation. Further embodiments of the present disclosure allow for improved safety of the power trigger mechanism, and improved control and stability in handling of a power tool by the operator.

### BRIEF DESCRIPTION OF THE DRAWINGS

So that the manner in which the above recited features of the present disclosure can be understood in detail, a more particular description of the disclosure, briefly summarized above, may be had by reference to embodiments. The accompanying drawings relate to embodiments of the disclosure and are described in the following:

FIG. 1 shows a perspective view of an exemplary power tool having a power trigger mechanism according to embodiments of the present disclosure;

FIG. 2 shows a perspective view of an exemplary grip of a power tool having a power trigger mechanism according to embodiments of the present disclosure;

FIG. 3 shows a side view of an exemplary grip of a power tool having a power trigger mechanism according to embodiments of the present disclosure;

FIGS. 4A-4D show schematic side views of the states of operation of a power trigger mechanism according to embodiments of the present disclosure;

FIGS. 5A-5D show schematic side views of the states of operation of a power trigger mechanism according to embodiments of the present invention; and

FIGS. 6A-6C show schematic side views of the states of operation of a power trigger mechanism according to embodiments of the present invention.

### DETAILED DESCRIPTION

Reference will now be made in detail to the various exemplary embodiments, one or more examples of which are illustrated in each figure. Each example is provided by way of explanation and is not meant as a limitation. For example, features illustrated or described as part of one embodiment can be used on or in conjunction with other embodiments to yield yet further embodiments. The intention is that the present disclosure includes such modifications and variations.

Within the following description of the drawings, the same reference numbers refer to same components. Only the differences with respect to the individual embodiments are described. The structures shown in the drawings are not necessarily depicted true to scale but rather serve the better understanding of the embodiments.

Various power tools may be controlled using a power trigger. In the context of the present disclosure, a “power tool” may generally refer to any tool which includes an energy source, a motor element to cause movement of the tool, and some form of control which is operated by an operator to activate the tool. A power tool according to the present disclosure is preferably an electrical power tool, particularly a battery-electric power tool, in which the energy source is a source of electricity and the motor element is an electric motor. Preferably, the energy source is a battery, particularly a lithium-ion battery. However, the present disclosure is not limited thereto, and the power tool may alternatively include a source of fuel and a combustion engine.

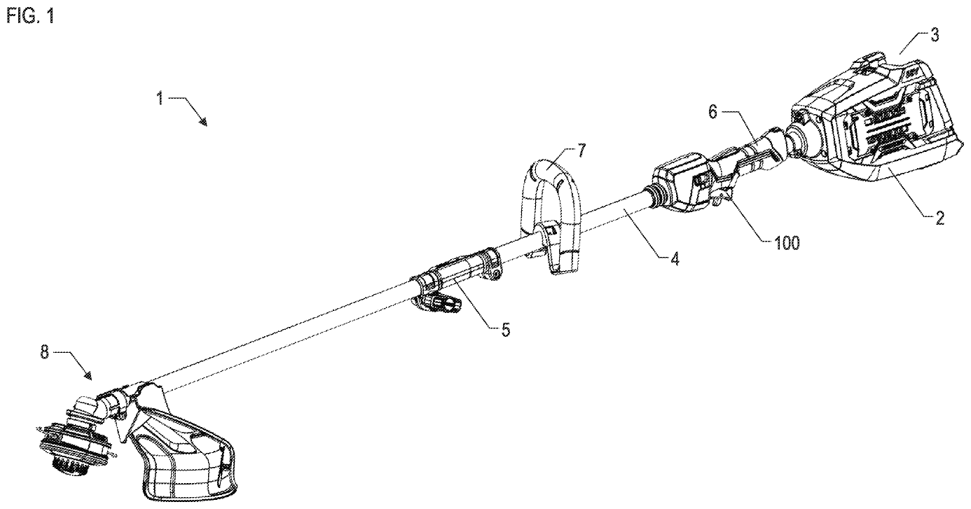

An exemplary power tool according to the present disclosure is shown in FIG. 1. The power tool 1 is exemplarily shown as a battery-powered garden tool including a motor element 2, a battery port 3 for an interchangeable battery and a tool element 8 to be driven by the motor element 2. The power tool 1 is exemplarily shown as having and a shaft 4 including a drive element arranged therein which mechanically connects the motor element 2 to the tool element 8. However, the power tool 1 is not limited thereto, and may alternatively have the motor element 2 arranged at the same end as the tool element 8. A tool attachment port 5 may be provided on the end of the shaft 4 for attaching one or more tool elements 8 to be driven by the drive element mechanically connected to the motor element 2. For example, the tool element 8 is exemplarily shown as a string cutter attachment. However, the present disclosure is not limited thereto, and other types of attachments are possible, such as a brush cutter blade attachment or a pole saw blade attachment.

The power tool as exemplarily shown is provided with a grip 6 to be handled by the operator for control of the power tool and optionally for supporting the power tool. The power tool may be further provided with a handle 7 spaced apart from the grip 6 which is further handled by the operator for control of the power tool and optionally for supporting the power tool.

According to embodiments of the present disclosure, the power tool may include a string trimmer, brush cutter, a hedge trimmer, a chain saw, a pole saw, a leaf blower or a lawn mower. However, the present disclosure is not limited thereto. A power trigger mechanism of the present disclosure may be applied to any power tool known in the art, particularly to hand-held power tools.

The power tool is controlled by an operator by the actuation of a power trigger mechanism 100. The power trigger mechanism 100 is exemplarily provided at the grip 6, such that the operator may handle and control the power tool, and optionally support the power tool, with one hand. In the present disclosure, aspects and embodiments of a power trigger mechanism for a power tool are described.

In the context of the present disclosure, the term “power trigger mechanism” refers to a user-operable mechanism which is operated to be unlocked and actuated, causing activation of the power tool. Particularly, a power trigger mechanism, after being unlocked by the particular actuation of two locking devices, may be operated by an operator to cause actuation of a power switch, a control switch or a control potentiometer of a power tool which causes an activation of the power tool.

Power trigger mechanisms of the current state of the art must be operated to actuate the locking devices in a specific sequence to unlock the trigger lever. Particularly, in conventional power trigger mechanisms, a second locking device must first be actuated and unlocked, for example with the thumb, to allow actuation of the first locking device. The first locking device may then be actuated and unlocked, for example with the palm, to allow actuation of the trigger lever to operate the power tool. Although the requirements of the safety regulations are fulfilled by conventional power trigger mechanisms, the operator is obliged to operate the locking devices in a specific sequence which is rigid and inflexible. Such power trigger mechanisms are less intuitive to the operator, and ease-of-use is reduced.

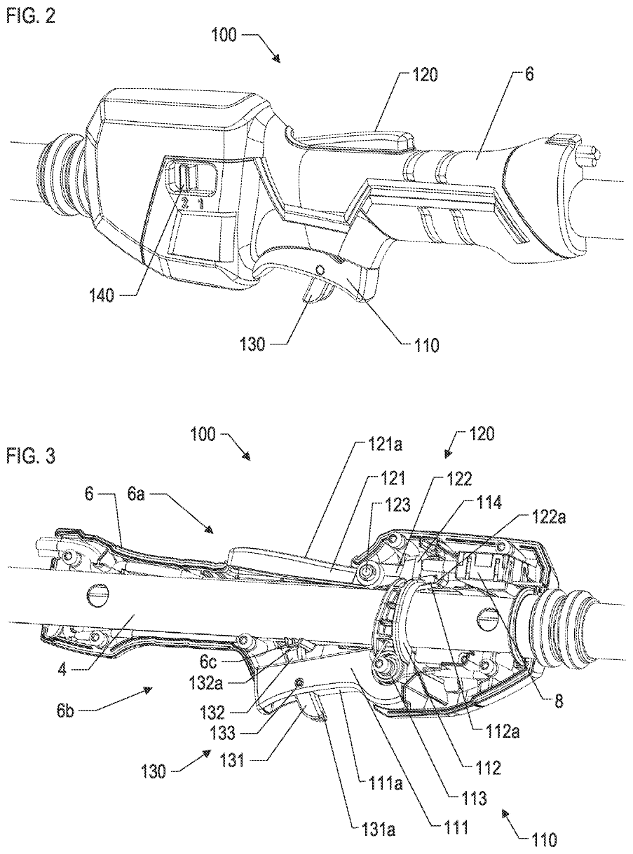

FIG. 2 shows an exemplary perspective view of the grip 6 at which a power trigger mechanism 100 is provided. The power trigger mechanism 100 is provided with a trigger lever 110, a first locking device 120 and a second locking device 130. The trigger lever 110 is configured to be actuated by the operator so as to activate the power tool, for example, by contacting a power switch, control switch or control potentiometer of the power tool. The first locking device 120 and the second locking device 130 are provided as safety devices which inhibit the actuation of the trigger lever 110. The power trigger mechanism 100 may optionally include auxiliary controls, such as a speed control 140 which allows for the operator to change the operating speed of the power tool. The speed control 140 would typically be actuated by the thumb of the operator.

The first locking device 120 is configured to be actuated by the operator into at least an unlocked state, and is configured to return to a locked state. When the first locking device 120 is in the locked state, an actuation of the trigger lever 110 is inhibited. Similarly, the second locking device 130 is also configured to be actuated by the operator into at least an unlocked state, and is configured to return to a locked state. When the second locking device 130 is in the locked state, an actuation of the trigger lever 110 is also inhibited.

In the context of the present disclosure, the terms “locked state” and “unlocked state” refer to two different states in which the respective element may be actuated. However, the provision of a “locked state” and an “unlocked state” does not limit the number of states in which the respective element may be actuated. For example, the respective element may be actuated into a “transitional state” between the locked state and the unlocked state.

When at least one of the first locking device 120 and the second locking device 130 is in the respective locked state, the trigger lever 110 is inhibited from being actuated by the operator. The term “inhibited” refers to a prevention or blocking of the trigger lever 110 from causing the activation of the power tool, particularly a prevention or blocking of the trigger lever 110 from contacting a power switch, control switch or control potentiometer of the power tool. The term “inhibiting” is not necessarily limited to stopping movement of the trigger lever 110. For example, the trigger lever 110 may be allowed a limited range of movement before being inhibited, as long as said limited range of movement does not cause activation of the power tool. The term “actuation of the trigger lever” refers to a sufficient amount of movement of the trigger lever to cause an activation of the power tool.

Conversely, the first locking device 120 and the second locking device 130 are configured to allow an actuation of the trigger lever 110 only when both the first and second locking devices are in the respective unlocked states. In other words, the operator is required to actuate both the first locking device 120 and the second locking device 130 to allow the power trigger mechanism to be in a fully unlocked state in which the trigger lever 110 is not inhibited by either the first locking device 120 or the second locking device 130, allowing an activation of the power tool.

In an aspect of the present invention, the first locking device 120 can be actuated independently of the state of the second locking device 130. Similarly, the second locking device 130 can be actuated independently of the state of the first locking device 120. For example, the first locking device 120 may be actuated so as to be moved into the unlocked state regardless of whether the second locking device 130 is in the locked state or the unlocked state, and vice versa. Independent actuation of the first locking device 120 and the second locking device 130 allows for the operator to fully unlock the power trigger mechanism in an arbitrary time sequence, or simultaneously, providing the safety of two locking devices according to regulations while also providing an intuitive and flexible method of operation.

Further disadvantages are evident from power trigger mechanisms of the current state of the art which require the thumb to operate. For example, in arrangements where both locking devices are arranged on the top of the power tool, or where one locking device is arranged on the side of the power tool (e.g. a locking button), the thumb is typically required to operate at least one of the locking devices. In operating the locking device with the thumb, the operator has reduced control and stability in handling the power tool, as the use of the thumb is important for gripping the power tool. In addition to this disadvantage, if the thumb is required to operate a locking device, the thumb would no longer be available for operating other auxiliary controls of the power tool, such as a speed control 140 which may be provided on the side of the power tool for adjusting the operating speed.

A further problem arises when both locking devices are arranged on the same side of the power tool and could both be operated with the palm of the operator, which compromises the safety of the mechanism due to allowing unlocking with a single operation, or both locking devices could be unlocked accidentally. Aspects and embodiments of the present disclosure are provided to overcome such disadvantages of conventional power trigger mechanisms.

FIG. 3 shows a side view of the power trigger mechanism 100 according to embodiments of the present disclosure. A portion of a housing of the grip 6 is hidden for clarity. The power trigger mechanism 100 is exemplarily shown as being provided at the grip 6 such that portions of the trigger lever 110, first locking device 120 and second locking device 130 are outside of the grip 6 so as to be accessible by the operator, and the remaining portions of the power trigger mechanism 100 are inside of the grip 6.

The grip 6 is arranged so as to be grasped by the operator using the hand. The grip 6 may include any surface of the power tool configured for being gripped or grasped by the operator when the power tool is in use. For example, the grip 6 may be configured for control of the power tool and/or for support or holding of the power tool. The grip 6 includes a first side 6a and a second side 6b opposite to the first side 6a, e.g. a top side and a bottom side, or a front side and a back side.

In typical operation, the operator contacts a first side 6a of the grip 6 with a palm portion of the hand, reaching around the grip and contacting a second side 6b of the grip 6 with the finger portions of the hand. The thumb portion of the hand contacts a surface of the grip 6 to grasp the grip 6. The grasping of the grip 6 by the thumb improves stability and control of the power tool of the operator as compared to grasping the grip 6 only with the palm and fingers, particularly in the case where the operator is supporting the weight of the power tool. Further, the thumb portion of the hand is available for actuating other auxiliary controls of the power tool, such as a speed control 140. In the context of the present disclosure, the term “finger” refers to one of the index finger, the middle finger, the ring finger or the little finger of the hand, i.e. the 2^{nd} to 5^{th} digits of the hand, which are the digits of the hand not including the thumb.

According to an embodiment, which may be combined with other embodiments described herein, the power trigger mechanism 100 is arranged at a grip 6, the first locking device 120 is arranged at a first side 6a of the grip 6, and the second locking device 130 is arranged at a second side 6b of the grip 6 opposite to the first side 6a.

According to further embodiments, the first locking device 120, arranged at the first side 6a of the grip 6, is configured to be actuated by a first part of the hand of the operator, and the second locking device 130, arranged at the second side 6b of the grip 6, is configured to be actuated by a second part of the hand of the operator different from the first part. Particularly, the first part of the hand of the operator is the palm of the hand, specifically a palm portion of the hand. The first locking device 120 may be actuated by the palm of the hand of the operator when the operator is grasping the grip 6, so as to actuate the first locking device 120 into the unlocked state.

Particularly, the second part of the hand of the operator is one or more fingers of the hand, specifically a finger portion of the hand. The second locking device 130 may be actuated by a finger of the operator is grasping the grip 6, so as to actuate the second locking device 130 into the unlocked state.

By providing the first locking device 120 and the second locking device 130 on opposite sides of the grip 6, safety of the power trigger mechanism 100 is improved. For example, the power trigger mechanism 100 is not able to be fully unlocked by actuation from only one side of the grip, e.g. when the power tool is set down directly onto the power trigger mechanism, or when an object is placed thereon. Further, by providing the first locking device 120 and the second locking device 130 on opposite sides of the grip 6, the thumb of the operator remains free to grasp the grip 6 of the power tool without operating one of the locking devices, providing an improvement to control and stability of the power tool when in operation, Further, the thumb portion of the hand is available for actuating other auxiliary controls of the power tool, such as a speed control 140. In addition, the arrangement of first locking device 120 and second locking device 130 is an ambidextrous design, allowing operation of the first locking device 120 and second locking device 130 of the power trigger mechanism 100 by either the left or right hand of the operator.

In the following, exemplary details of the power trigger mechanism 100 according to the present disclosure, particularly the trigger lever 110, the first locking device 120 and the second locking device 130, are discussed.

An exemplary trigger lever 110 may include a first extending portion 111, a second extending portion 112 and a trigger lever pivot axis 113. First extending portion 111 may extend outwards from the trigger pivot 113 and may include an actuating surface 111a configured to be actuated by the operator, particularly at least one finger of the operator. Second extending portion 112 may extend outwards from the trigger lever pivot axis 113 and may extend around the shaft 4 of the power tool from the second side 6b of the grip 6 to the first side 6a of the grip 6, and may include a protrusion 114 which is configured to contact the power switch 8 when the trigger lever 110 is actuated. First extending portion 111 and second extending portion 112 may be arranged at an angle to one another about trigger lever pivot axis 113. Actuation of the exemplary trigger lever 110 causes a rotation of the trigger lever 110 about trigger lever pivot axis 113, causing protrusion 114 to contact the power switch 8. For inhibiting the actuation of trigger lever 110 by the first locking device 120, the second extending portion 112 may be provided with a surface 112a which is configured to be abutted by a corresponding surface of the first locking device 120 when the first locking device 120 is in the locked state. When the first locking device 120 is in the unlocked state, the surface 112a of the extending portion 112 would not be abutted, and the trigger lever 110 would not be inhibited by the first locking device 120.

An exemplary first locking device 120 may include a first extending portion 121, a second extending portion 122 and a first locking device pivot axis 123. The first locking device pivot axis 123 may be provided in a fixed position relative to the power tool, particularly relative to the grip of the power tool. First extending portion 121 may extend outwards from the first locking device pivot axis 123 and may include an actuating surface 121a configured to be actuated by the operator, particularly by the palm of the operator. First extending portion 121 and second extending portion 122 may be arranged to be approximately in line with each other. Second extending portion 122 may extend outwards from the first locking device pivot axis 123 and may include a surface 122a which abuts the surface 112a of the trigger lever 110 when the first locking device 120 is in the locked state. For example, the surface 122a may include a hook protrusion configured to hook onto the corresponding surface 112a of the trigger lever.

An exemplary second locking device 130 may include a first extending portion 131, a second extending portion 132 and a second locking device pivot axis 133. The second locking device pivot axis 133 may be provided in a fixed position relative to the trigger lever 110, particularly provided on the trigger lever 110. First extending portion 131 may extend outwards from the second locking device pivot axis 133 and includes an actuating surface 131a configured to be actuated by the operator, particularly by a finger of the operator. First extending portion 131 and second extending portion 132 may be arranged to be approximately in line with each other. Second extending portion 132 may extend outwards from the first locking device pivot axis 133 and may include a surface 132a which abuts a surface 6c of the power tool when the first locking device 120 is in the locked state. The surface 6c is exemplarily shown as a portion of the grip 6, but may alternatively be a portion of the shaft 4. The second locking device 130 may be configured to rotate about the pivot axis 133 so that the surface 132a no longer abuts the surface 6c of the power tool so that the second locking device 130 no longer inhibits actuation of the trigger lever 110. When in the unlocked state, the second locking device 130 may lie within trigger lever 110, and the actuating surface 131a of the second locking device 130 may be aligned with the actuating surface 111a of the trigger lever 110 so that a substantially continuous actuating surface is provided.

According to embodiments, which may be combined with other embodiments described herein, the power trigger mechanism 100 may further include at least one return element configured for at least one of returning the first locking device 120 to the locked state when the trigger lever 110 is in a non-actuated state, returning the second locking device 130 to the locked state when the trigger lever 110 is in a non-actuated state, and returning the trigger lever 110 to the non-actuated state. The at least one return element may be, for example, a spring or elastic member which causes the respective locking device to return to a locked state, and/or causes trigger lever to return to a non-actuated state, when the operator releases the respective device. The return element may include one of a compression spring, a tension spring or a torsion spring, or may be a portion of the respective device which is flexible.

In particular, the at least one return element may cause a respective locking device and/or the trigger lever to return into a “default state”. A default state is a respective state in which the trigger lever 110, the first locking device 120 and/or the second locking device 130 is maintained when the operator is not actuating the respective device. In particular, the respective default states for the first locking device 120 and the second locking device 130 is the locked state, and the default state for the trigger lever 110 is the non-actuated state in which the power tool is not activated.

In the same manner as the actuation of the first locking device 120 and the second locking device 130, the returning of the first locking device 120 may be independent upon the state of the second locking device 130, and vice versa. For example, the first locking device 120 may be returned by a respective return element to the locked state or default state regardless of whether the second locking device 130 is in the locked state or the unlocked state, and the second locking device 130 may be returned by a respective return element to the locked state or default state regardless of whether the first locking device 120 is in the locked state or the unlocked state. The independent nature of the returning of each respective locking device improves safety of the power trigger mechanism, as the trigger lever 110 may be inhibited by the return of either one of the first locking device 120 and second locking device 130.

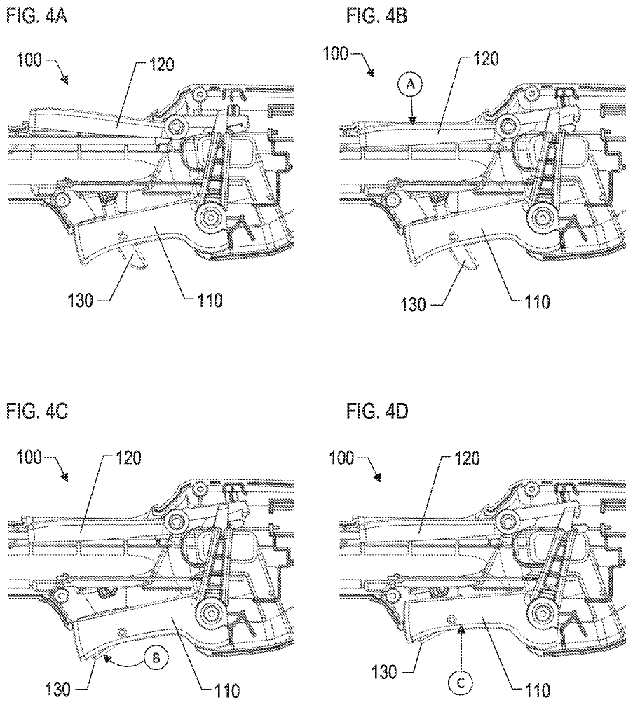

Reference will now be made to FIGS. 4A-4D, FIGS. 5A-5D and FIGS. 6A-6C, which show the various states of operation of the power trigger mechanism 100 according to aspects and embodiments of the present disclosure.

In a first sequence of operation, FIG. 4A shows the trigger lever 110 is in an unactuated state, i.e. a default state, and both the first locking device 120, the second locking device 130 are their respective locked states, i.e. their respective default states. In FIG. 4B, the first locking device 120 is actuated into an unlocked state by operation A. At this point, trigger lever 110 is still inhibited from being actuated by the second locking device 130. In FIG. 4C, the second locking device 130 is actuated into an unlocked state by operation B, such that trigger lever 110 is no longer inhibited. Finally, in FIG. 4D the trigger lever 110 is actuated by operation C so as to activate the power tool.

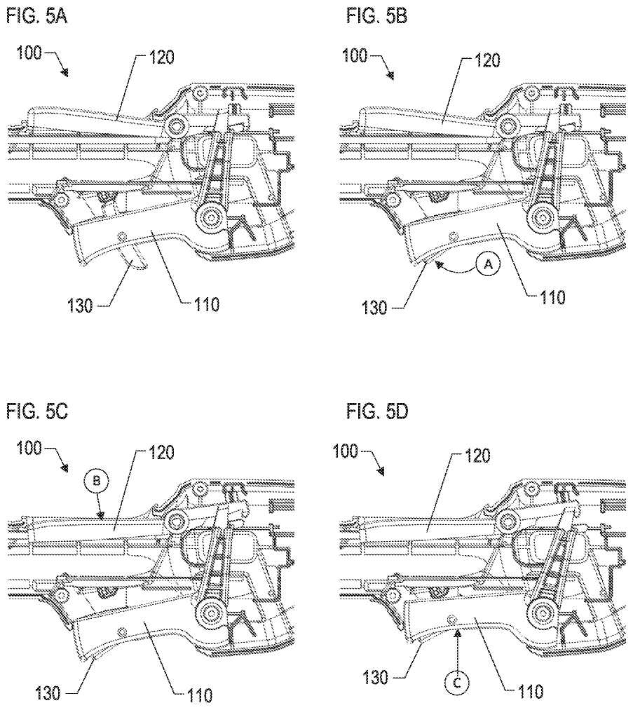

To demonstrate the flexible sequence of operating the power trigger mechanism 100, FIGS. 5A-5D show an alternative sequence. In FIG. 5A, the trigger lever 110 is in an unactuated state, i.e. a default state, and both the first locking device 120, the second locking device 130 are their respective locked states, i.e. their respective default states. In FIG. 5B, the second locking device 130 is actuated into an unlocked state by operation A. At this point, trigger lever 110 is still inhibited from being actuated by the first locking device 120. In FIG. 5C, the first locking device 120 is actuated into an unlocked state by operation B, such that trigger lever 110 is no longer inhibited. Finally, in FIG. 5D the trigger lever 110 is actuated by operation C so as to activate the power tool.

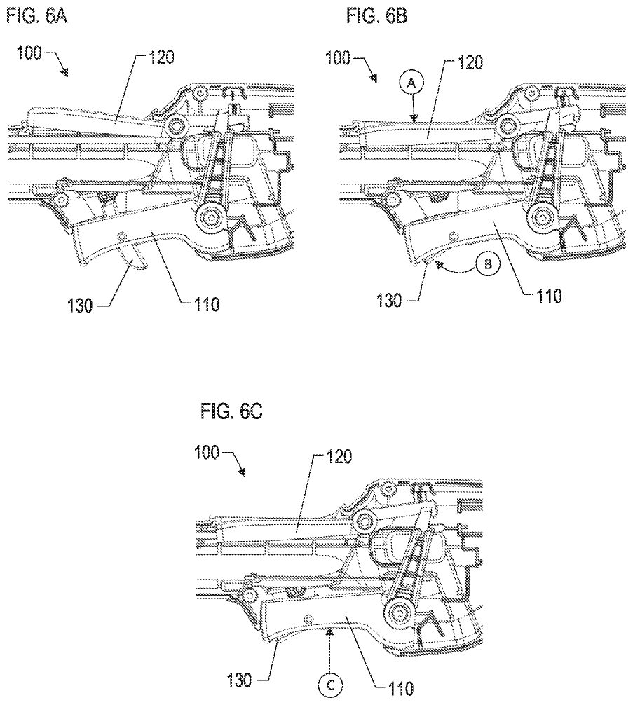

As a further demonstration of the flexible sequence of operating the power trigger mechanism 100, FIGS. 6A-6C show another alternative sequence. In FIG. 6A, the trigger lever 110 is in an unactuated state, i.e. a default state, and both the first locking device 120, the second locking device 130 are their respective locked states, i.e. their respective default states. In FIG. 6B, the first locking device 120 and the second locking device 130 are both simultaneously actuated into an unlocked state by operations A and B, respectively. At this point, trigger lever 110 is no longer inhibited. Finally, in FIG. 6C the trigger lever 110 is actuated by operation C so as to activate the power tool.

Accordingly, a further aspect of the present disclosure provides a method of operation of a power trigger mechanism. Particularly, the method relates to the operation of a power trigger mechanism 100 according to aspects and embodiments of the present disclosure. The method includes actuating one of the first locking device 120 and the second locking device 130 from the locked state to the unlocked state, actuating the other one of the first locking device 120 and the second locking device 130 from the locked state to the unlocked state, and actuating the trigger lever 110. The sequence of operations for fully unlocking the trigger lever 110 is independent, that is the unlocking of the first locking device 120 is not dependent upon the state of the second locking device 130 and vice versa.

According to an embodiment, which may be combined with other embodiments described herein, the actuating of the first locking device 120 and the actuating B of the second locking device 130 is performed simultaneously.

According to an embodiment, which may be combined with other embodiments described herein, the actuating of the first locking device 120 may be performed by a first part of a hand of an operator, and the actuating of the second locking device 130 may be performed by a second part of the hand of the operator different from the first part. According to further embodiments, the first part of the hand of the operator is a palm portion, and the second part of the hand of the operator is a finger portion. In this manner, the thumb is free to grasp the power tool, particularly the grip 6 of the power tool, providing improved control and stability in handling the power tool, and is further available to operate auxiliary controls of the power tool, such as a speed control 140.

According to an extended method, the power trigger mechanism 100 further includes at least one return element, and the method further includes releasing the trigger lever 110 allowing the trigger lever 110 to return to a non-actuated state, releasing one of the first locking device 120 and the second locking device 130 allowing the respective locking device to return to a locked state, and releasing the other one of the first locking device 120 and the second locking device 130 allowing the respective locking device to return to a locked state. Particularly, the returning of the first locking device 120 and the second locking device 130 into their respective locked states can be carried out independently of one another, which improves safety of the locking devices due to the releasing of a respective locking device being possible regardless of the state of the other locking device. Further, the independent return of each one of the first locking device and the second locking device provides redundancy in the case where, for example during operation by the operator, one of the locking devices may be damaged or made otherwise inoperable.

While the foregoing is directed to some embodiments, other and further embodiments may be devised without departing from the basic scope thereof, and the scope thereof is determined by the claims that follow.

1. A power trigger mechanism for a power tool, the power trigger mechanism comprising:
a trigger lever configured to be actuated by an operator;
a first locking device configured to be actuated by the operator into an unlocked state, and configured to return to a locked state in which an actuation of the trigger lever is inhibited; and
a second locking device configured to be actuated by the operator into an unlocked state, and configured to return to a locked state in which an actuation of the trigger lever is inhibited,
wherein the first locking device and the second locking device are configured to allow an actuation of the trigger lever only when both the first locking device and the second locking device are in the respective unlocked states,
the first locking device can be actuated independently of the state of the second locking device, and
the second locking device can be actuated independently of the state of the first locking device.

2. The power trigger mechanism according to claim 1, wherein the power trigger mechanism is arranged at a grip, the first locking device is arranged at a first side of the grip, and the second locking device is arranged at a second side of the grip opposite to the first side.

3. The power trigger mechanism according to claim 1, wherein the first locking device comprises a surface of the first locking device (120) which abuts a surface of the trigger lever in the locked state to inhibit actuation of the trigger lever.

4. The power trigger mechanism according to claim 1, wherein the first locking device comprises a pivot axis arranged on the power tool such that the first locking device is rotatable between the locked state and the unlocked state.

5. The power trigger mechanism according to claim 1, wherein the second locking device comprises a surface of the second locking device which abuts a surface of the power tool in the locked state to inhibit actuation of the trigger lever.

6. The power trigger mechanism according to claim 1, wherein the second locking device comprises a pivot axis arranged on the trigger lever such that the second locking device is rotatable between a locked position and an unlocked position.

7. The power trigger mechanism according to claim 1, wherein the first locking device is configured to be actuated by a first part of a hand of the operator, and the second locking device is configured to be actuated by a second part of the hand of the operator different from the first part, particularly wherein the first part of the hand of the operator is a palm portion and the second part of the hand of the operator is a finger portion.

8. The power trigger mechanism according to claim 1, further comprising at least one return element configured for at least one of:
returning the first locking device to the locked state when the trigger lever is in a non-actuated state;
returning the second locking device to the locked state when the trigger lever is in the non-actuated state; or
returning the trigger lever to the non-actuated state.

9. A power tool comprising:
an energy source;
a motor element; and
the power trigger mechanism according to claim 1.

10. The power tool of claim 9, wherein the power tool is one of the group comprising a string trimmer, a brush cutter, a hedge trimmer, a chain saw, a pole saw, a leaf blower and a lawn mower.

11. A method of operating a power trigger mechanism comprising a trigger lever, a first locking device configured to be actuated into an unlocked state and configured to return to a locked state in which an actuation of the trigger lever is inhibited, and a second locking device configured to be actuated into an unlocked state and configured to return to a locked state in which an actuation of the trigger lever is inhibited, wherein the first locking device and the second locking device are configured to allow an actuation of the trigger lever only when both the first locking device and second locking device are in the respective unlocked states, the method comprising:
actuating one of the first locking device and the second locking device from the locked state to the unlocked state;
actuating the other one of the first locking device and the second locking device from the locked state to the unlocked state; and
actuating the trigger lever.

12. The method according to claim 11, wherein the actuating of the first locking device and the actuating of the second locking device is performed simultaneously.

13. The method according to claim 11, wherein the actuating of the first locking device is performed by a first part of a hand of an operator, and the actuating of the second locking device is performed by a second part of the hand of the operator different from the first part.

14. The method according to claim 13, wherein the first part of the hand of the operator is a palm portion, and the second part of the hand of the operator is a finger portion.

15. The method according to claim 11, wherein the power trigger mechanism is arranged on a grip, the first locking device is arranged on a first side of the grip, and the second locking device is arranged on a second side of the grip opposite to the first side.
